(19) United States
(12) Patent Application Publication
(10) Pub. No.: US 2010/0051355 A1
(43) Pub. Date: Mar. 4, 2010

(54) CAPACITIVE TOUCH PANEL

(76) Inventor: Kai-Ti Yang, Taoyuan (TW)

Correspondence Address: Kai-Ti Yang, 235 Chung - Ho, Box 8-24, Taipei, TW

(21) Appl. No.: 12/202,316

(22) Filed: Aug. 31, 2008

(51) Int. Cl. G06F 3/044

(52) U.S. Cl. 178/18.06

(57) ABSTRACT

An improved structure of capacitive touch panel mainly improves the arrangement of induction-spots on ends of X and Y axis traces so that the capacitive sensing area on edges of the working area of a touch panel are arranged equally. Thus, the sensing signals on edges of the working area of the touch panel can be detected so as to maximize the actual effecting area of the touch panel.

### FIELD OF THE PRESENT INVENTION

The present invention relates to touch panel, and particular to a touch panel positioning by a capacitive sensing method.

### DESCRIPTION OF THE PRIOR ART

Recently, capacitive touch panels are widely used on electronic products such as the mouse pad of a laptop, or being equipped on the screens of a cell phone, a Personal Digital Assistant (PDA), a Global Positioning System (GPS), and other small electronic products. A common structure of the capacitive touch panel includes a plurality of X and Y axis traces distributed on the working area. Each of the X and Y axis traces are conducted to a signal processing circuit respectively. During operating, when a finger or a conductor touches on a certain position on the surface of the working area, the signal processing circuit can locate the position by the variation of the capacitance. However, as shown in FIG. 3, the X and Y axis trace of a prior capacitive touch panel is vertically or transversely linked by rhombic induction-spots. On the edges of the working area, the induction-spots will be partially or entirely cut by the edges so that the X and Y sensing signals can not be detected precisely. Theoretically, the effective area Al of the touch panel shall cover all the area of the induction-spots. While under an actual test, when touching the edges of the area A1 by a finger or conductor, it happens that only one of the X and Y signals is detected and the signal can not be located. So, the actual effective area A2 of the prior capacitive touch panel is to shrink from the theoretical area A1 at least 3 to 5 mm. It will seriously restrain the effective area of the touch panel, especially to the applications with a smaller touch panel such as a cell phone or PDA. Moreover, the unusable edges will restrain the application and outer appearance design of the correlative. Therefore, to enlarge the actual effective area of the touch panel is one of the most important subjects.

### SUMMARY OF THE PRESENT INVENTION

Accordingly, the present invention provides an improved structure of capacitive touch panel which the sensing areas of induction-spot of X and Y axis traces on the edges of touch panel are formed equally. Thus, issue of only one of the X or Y capacitive signal being detected on the edges area will be avoided and the effective working area of the touch panel will be maximized.

The various objects and advantages of the present invention will be more readily understood from the following detailed description when read in conjunction with the appended drawing.

### BRIEF DESCRIPTION OF THE DRAWINGS

FIG. 1 is a structural view of a sensing layer of the present invention.

FIG. 2 is a structural view of a sensing layer of another embodiment of the present invention; and

FIG. 3 is structural view of a sensing layer of a prior capacitive touch panel.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

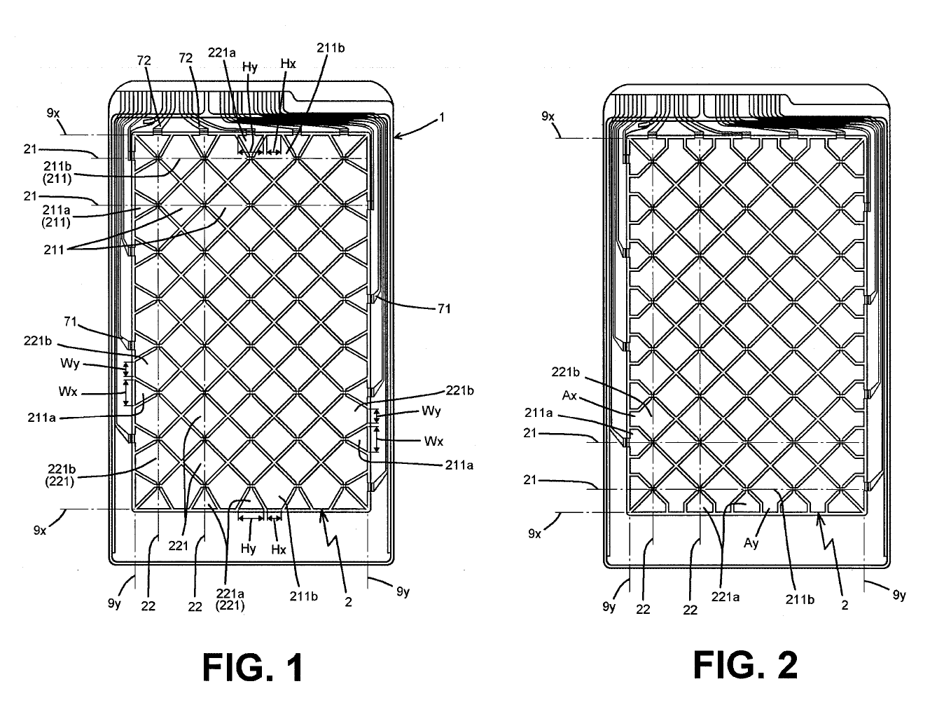

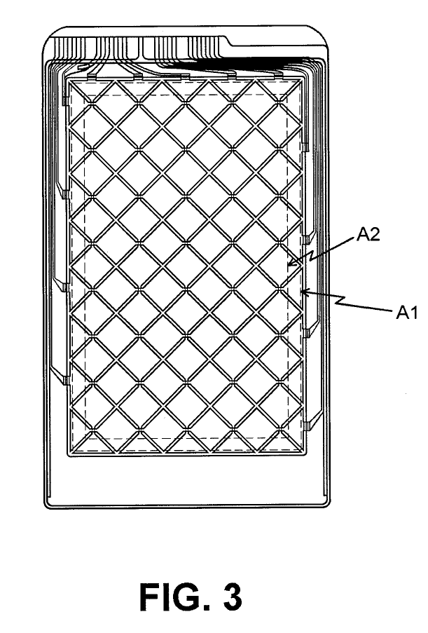

As shown in FIG. 1, an embodiment of the present invention is a capacitive touch panel which is a layered plates assembled by a panel layer, a sensing layer for capacitive signal, and a substrate layer. The panel layer and the substrate layer are selected by insulated thin films, and the sensing layer is selected by a transparent thin film with highly conductivity. For the purpose of having a transparent touch panel on the screen of an electronic device, the panel layer can be selected by a highly transparent insulated material such as Polythylene terephthalate (PET). The substrate layer can be selected by a transparent hard material such as a clear glass, or an acrylic plate. The sensing layer can be selected by a thin film with highly conductivity such as an Indium Tin Oxide (ITO) film.

The sensing layer 2 for the capacitive signal has a plurality of transparent X axis traces 21 which are arranged in parallel with a fixed interval between, and also includes a plurality of transparent Y axis traces 22 which are arranged in parallel with a fixed interval between. The X and Y traces 21, 22 intersect with each other as a matrix and are insulated from each other induction-spots 211 are connected one by one along each X axis trace, and an end of each X axis trace is connected to a silver conducting wire 71 induction-spots 221 are connected one by one along each Y axis trace, and an end of each Y axis trace is connected to a silver conducting wire 72. The sliver conducting wires 71 and 72 are gathered and conducted to a signal output wire bank (not shown) so that a sensing capacitive signal on the sensing layer 2 can be transmitted to a succeeding signal processing circuit through the signal output wire bank. In the above mentioned structure, an equivalent capacity is formed between the X axis trace 21 and the silver conducting wire 71, and also between the Y axis trace 22 and the silver conducting wire 72. When a finger or a conductor touches or slides on a certain position on the surface of the touch panel, the signal processing circuit can locate the position by the variation of the capacitance.

With reference to FIG. 1, on the four edges of the sensing layer 2 in the embodiment of the present invention, the induction-spots 211a on the ends of the X axis traces which cut by the Y axis edges 9y are formed roughly as triangles, and the adjacent induction-spots 221b of the Y axis traces are formed roughly as pentagons. While the induction-spots 221a on the ends of the Y axis traces which cut by the X axis edges 9x are formed roughly as triangles, and the adjacent induction-spots 211b of the X axis traces are formed roughly as pentagons. Preferably, the section width Wx of the induction-spots 211a on the ends of the X axis traces cut by the Y axis edges 9y and the section width Wy of the adjacent induction-spots 221b of the Y axis traces cut by the Y axis edges 9y have a ratio of Wx:Wy around 6:1 to 1:6. The section width Hy of the induction-spots on the ends of the Y axis traces cut by the X axis edges 9x and the section width Hx of the adjacent induction-spots of the X axis trace cut by the X axis edges 9x have a ratio of Hy:Hx around 6:1 to 1:6. Therefore, the capacitive sensing areas of the induction-spots of the X and Y axis traces near the edges 9x and 9y are formed equally so that the touch sensing signals of the X and Y axis traces can be detected on the edges of the working area on the touch panel. Thus, the edge areas can not be operated, which is the disadvantage of the prior capacitive touch panel is solved.

On the edges of the sensing layer 2 as mentioned above, the shape of the induction-spots 211a on the ends of the X axis traces and the adjacent induction-spots 221b of the Y axis traces, also the shape of the induction-spots 221a on the ends of the Y axis traces and the adjacent induction-spots 211b of the X axis traces can be switched. That is, the induction-spots 211a on the ends of the X axis traces are formed as pentagons, and the adjacent induction-spots 221b of the Y axis traces are formed as triangles. While the induction-spots 221a on the ends of the Y axis traces are formed as pentagons, and the adjacent induction-spots 211b of the X axis traces are formed as triangles. The same effect will be achieved under such switch of the shape and arrangement.

Otherwise, another embodiment of the present invention is illustrated in FIG. 2. On the edges of the sensing layer 2, the induction-spots 211a on the ends of the X axis traces cut by the edges 9y are formed roughly as pentagons, and the adjacent induction-spots 221b of the Y axis traces cut by the edges 9y are formed with an extra area Ax which protrudes outwards to the edges 9y. While the induction-spots 221a on the ends of the Y axis traces cut by the edges 9x are formed as pentagons, and the adjacent induction-spots 211b of the X axis traces are formed with an extra area Ay which protrudes outwards to the edges 9x. In the same way, the shape and arrangement on the edges of the sensing layer 2 can be switched between the induction-spots 211a on the ends of the X axis traces and the adjacent induction-spots 221b of the Y axis traces, and also between the induction-spots 221a on the ends of the Y axis traces and the adjacent induction-spots 211b of the X axis traces.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A capacitive touch panel comprising a sensing layer for capacitive signal, wherein the sensing layer has a plurality of X and Y traces intersected with each other as a matrix and insulated from each other; induction-spots are connected one by one along each X axis trace, and induction-spots are connected one by one along each Y axis trace; an end of each X and Y axis trace is connected to a silver conducting wire and further conducted to a signal output wire bank; on the edges of the sensing layer, a section width Wx of the induction-spots on the ends of the X axis traces cut by Y axis edges and a section width Wy of the adjacent induction-spots of the Y axis traces cut by the Y axis edges have a ratio of Wx:Wy around 6:1 to 1:6; a section width Hy of the induction-spots on the ends of the Y axis traces cut by the X axis edges and a section width Hx of the adjacent induction-spots of the X axis traces cut by the X axis edges have a ratio of Hy:Hx around 6:1 to 1:6.

2. A capacitive touch panel as claimed in claim 1, wherein the induction-spots on the ends of the X axis traces which cut by the Y axis edges are formed roughly as triangles, and the adjacent induction-spots of the Y axis traces which cut by the Y axis edges are formed roughly as pentagons; while the induction-spots on the ends of the Y axis traces which cut by the X axis edges are formed roughly as triangles, and the adjacent induction-spots of the X axis traces which cut by the X axis edges are formed roughly as pentagons.

3. A capacitive touch panel as claimed in claim 1, wherein the induction-spots on the ends of the X axis traces which cut by the Y axis edges are formed roughly as pentagons, and the adjacent induction-spots of the Y axis traces which cut by the Y axis edges are formed roughly as triangles; while the induction-spots on the ends of the Y axis traces which cut by the X axis edges are formed roughly as pentagons, and the adjacent induction-spots of the X axis traces which cut by the X axis edges are formed roughly as triangles.

4. A capacitive touch panel as claimed in claim 1, wherein the induction-spots on the ends of the X axis traces cut by the Y axis edges are formed roughly as pentagons, and the adjacent induction-spots of the Y axis traces cut by the Y axis edges are formed with an extra area which protrudes outwards to the Y axis edges; while the induction-spots on the ends of the Y axis traces cut by the X axis edges are formed roughly as pentagons, and the adjacent induction-spots of the X axis traces cut by the X axis edges are formed with an extra area which protrudes outwards to the X axis edges.

5. A capacitive touch panel as claimed in claim 1, wherein the induction-spots on the ends of the X axis traces cut by the Y axis edges are formed with an extra area which protrudes outwards to the Y axis edges, and the adjacent induction-spots of the Y axis traces cut by the Y axis edges are formed roughly as pentagons; while the induction-spots on the ends of the Y axis traces cut by the X axis edges are formed with an extra area which protrudes outwards to the X axis edges, and the adjacent induction-spots of the X axis traces cut by the X axis edges are formed roughly as pentagons.
